(19) United States
(12) Patent Application Publication
(10) Pub. No.: US 2012/0317965 A1
(43) Pub. Date: Dec. 20, 2012

(54) AUTOMATED HYDRAULIC POWER SYSTEM AND A METHOD OF OPERATING AN AUTOMATED HYDRAULIC POWER SYSTEM

(75) Inventor: Francis Edward Pagnotta, JR., Chambersburg, PA (US)

(73) Assignee: VOLVO CONSTRUCTION EQUIPMENT AB, Eskilstuna (SE)

(21) Appl. No.: 13/578,683

(22) PCT Filed: Feb. 17, 2010
(86) PCT No.: PCT/US10/24356

§ 371 Date: Aug. 13, 2012

(51) Int. Cl. F16H 61/38; F15B 21/08; F15B 13/16

(52) U.S. Cl. 60/327; 417/319; 417/34; 60/435; 417/53

(57) ABSTRACT

The present a hydraulic system and a method for operating a hydraulic system that includes an engine, at least one hydraulic pump, a pump box interposed between the engine and the at least one hydraulic pump, at least one hydraulic clutch pack interposed between the pump box and the at least one hydraulic pump, at least one valve, a hydraulic fluid reservoir, a clutch actuation pump, and one or more electronics. The at least one hydraulic clutch pack selectively transmits torque to the at least one hydraulic pump. The at least one valve may be opened to supply pressurized hydraulic fluid to the at least one clutch pack and may be closed to interrupt a supply of pressurized hydraulic fluid to the at least one clutch pack in order to selectively engage or disengage the clutch pack.

### FIELD OF THE INVENTION

The present invention relates to an automated hydraulic power system and a method of operating an automated hydraulic power system.

### BACKGROUND OF THE INVENTION

Many types of equipment and machinery utilize hydraulic power, such as that generated by hydraulic pumps, as drive systems for a variety of components. Machinery and equipment, such as, for example, construction equipment, may often times include a pump box, which receives mechanical power from an engine and outputs this mechanical power to a number of hydraulic pumps, which in turn through hydraulic pressure, drives a number of hydraulic actuators, including, for example, hydraulic cylinders and hydraulic motors.

One problem that arises with hydraulic power systems occurs during cold weather starting conditions. During cold weather start up, increased hydraulic fluid viscosity and the associated hydraulic load of the hydraulic pumps may make it difficult to start the engine. Accordingly, it is conventional to disable the hydraulic power system through use of a clutch interposed between the engine and the pump box. With this arrangement, the hydraulic power system is disabled until the engine is warmed up and can be started with the clutch engaged.

Another problem that arises with hydraulic power systems occurs in situations where the hydraulic actuator, such as the hydraulic cylinder or hydraulic pump, is not being used to perform mechanical work. Operation of the hydraulic pumps during such a situation generates unnecessary horsepower load on the engine, which in turn decreases fuel efficiency. This arrangement also increases hydraulic heat buildup and pump component wear without producing beneficial results.

Yet another problem that arises with hydraulic power systems occurs due to the fact that the hydraulic load exerted on the engine varies according to a variety of operating conditions, including the number of hydraulic actuators operated at any one point in time and the load exerted on the hydraulic actuator. During high hydraulic load conditions, while it may be desirable to a user to operate the engine at a high speed, which, in turn, may lead to a decrease in fuel efficiency, should a user maintain the high engine speed during lower hydraulic load conditions, an unnecessary reduction in fuel efficiency may occur.

The present invention is directed towards an automated hydraulic power system and method

### SUMMARY OF THE INVENTION

According to one embodiment of the present invention a hydraulic system and a method for operating a hydraulic system comprises an engine, at least one hydraulic pump, a pump box, at least one hydraulic clutch pack, at least one valve, a hydraulic fluid reservoir, a clutch actuation pump, and one or more electronics. The pump box is interposed between the engine and the at least one hydraulic pump, whereby the pump box receives mechanical power generated by the engine and transmits torque for use by the at least one hydraulic pump. The at least one hydraulic clutch pack is interposed between the pump box and the at least one hydraulic pump for selectively transmitting torque to the at least one hydraulic pump, wherein the at least one clutch pack may be selectively engaged or disengaged, whereby the hydraulic load associated with the at least one hydraulic pump is applied to the engine when the clutch pack is engaged. The at least one valve may be opened to supply pressurized hydraulic fluid to the at least one clutch pack and may be closed to interrupt a supply of pressurized hydraulic fluid to the at least one clutch pack in order to selectively engage or disengage the clutch pack. The clutch actuation pump that pumps the hydraulic fluid from the hydraulic fluid reservoir to the at least one valve. The one or more electronics control the opening and closing of the at least one valve.

According to another embodiment of the present invention a method for operating a hydraulic system is provided, wherein the hydraulic system includes an engine, at least one hydraulic pump, a pump box interposed between the engine and the at least one hydraulic pump, whereby the pump box receives mechanical power generated by the engine and transmits torque for use by the at least one hydraulic pump, at least one hydraulic clutch pack interposed between the pump box and the at least one hydraulic pump for selectively transmitting torque to the at least one hydraulic pump, wherein the at least one clutch pack may be selectively engaged or disengaged, whereby the hydraulic load associated with the at least one hydraulic pump is applied to the engine when the clutch pack is engaged, a hydraulic fluid reservoir, and a clutch actuation pump that pumps the hydraulic fluid from the hydraulic fluid reservoir to at least one valve, the method comprises the step of selectively engaging or disengaging the clutch pack using one or more electronics to control the opening and closing of the at least one valve, wherein when the at least one valve is opened pressurized hydraulic fluid is supplied to the at least one clutch pack and wherein when the at least valve is closed the supply of pressurized hydraulic fluid to the at least one clutch pack is interrupted.

### BRIEF DESCRIPTION OF THE DRAWINGS

FIG. 1 shows a schematic of a hydraulic power system according to an embodiment of the present invention.

FIG. 2 depicts a schematic of a pump box according to an embodiment of the present invention.

FIG. 3 depicts a perspective view of a hydraulic power system according to an embodiment of the present invention.

FIG. 4 depicts a perspective view of a hydraulic clutch according to an embodiment of the present invention.

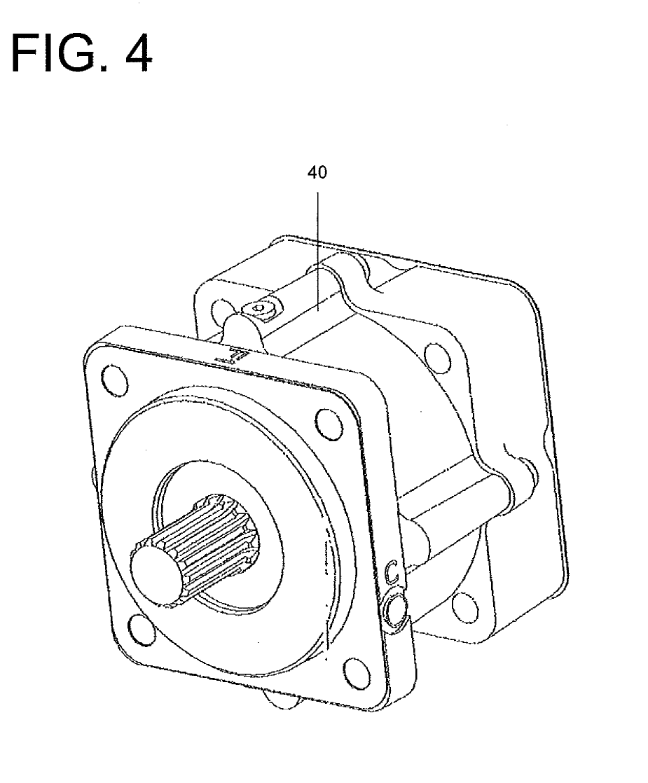

FIG. 5 depicts a perspective view partially in section showing a disengaged hydraulic clutch pack according to an embodiment of the present invention.

FIG. 6 shows a perspective view partially in section showing an engaged hydraulic clutch pack according to an embodiment of the present invention.

FIG. 7 depicts a closed valve schematic according to an embodiment of the present invention.

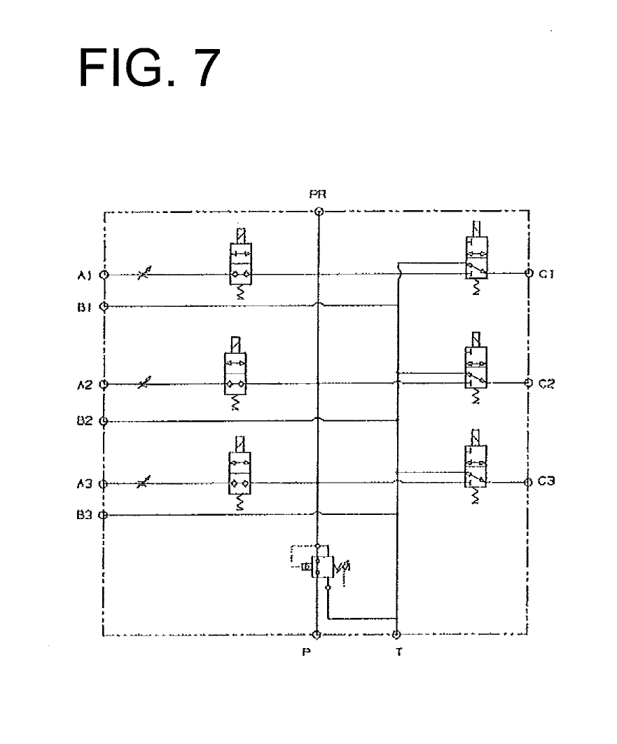

FIG. 8 depicts an open valve schematic according to one embodiment of the present invention.

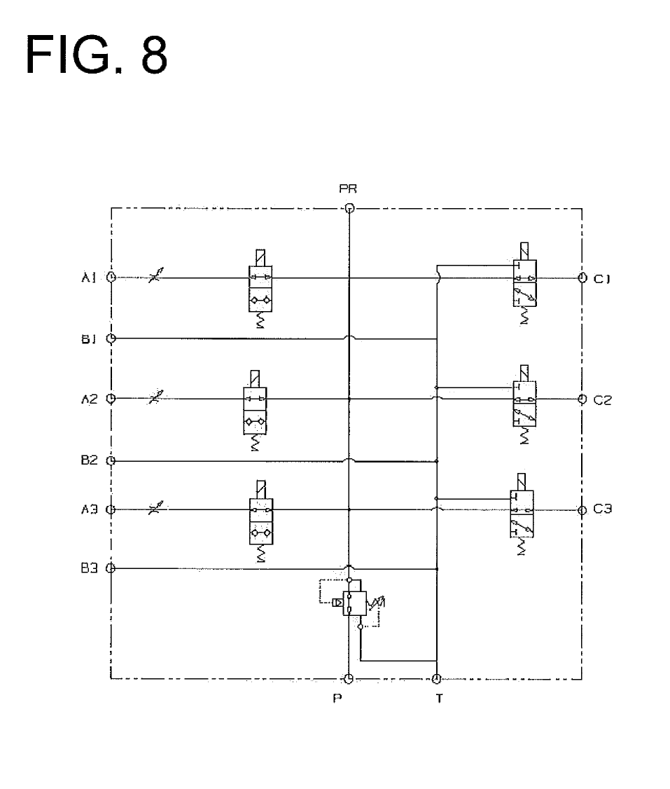

### DETAILED DESCRIPTION OF THE INVENTION

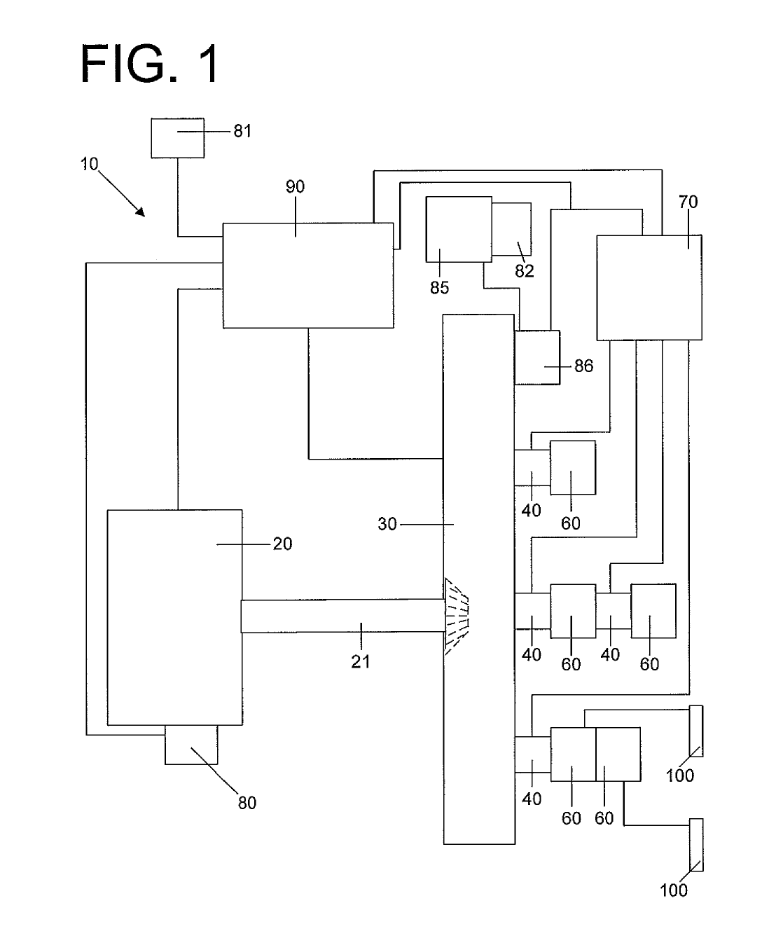

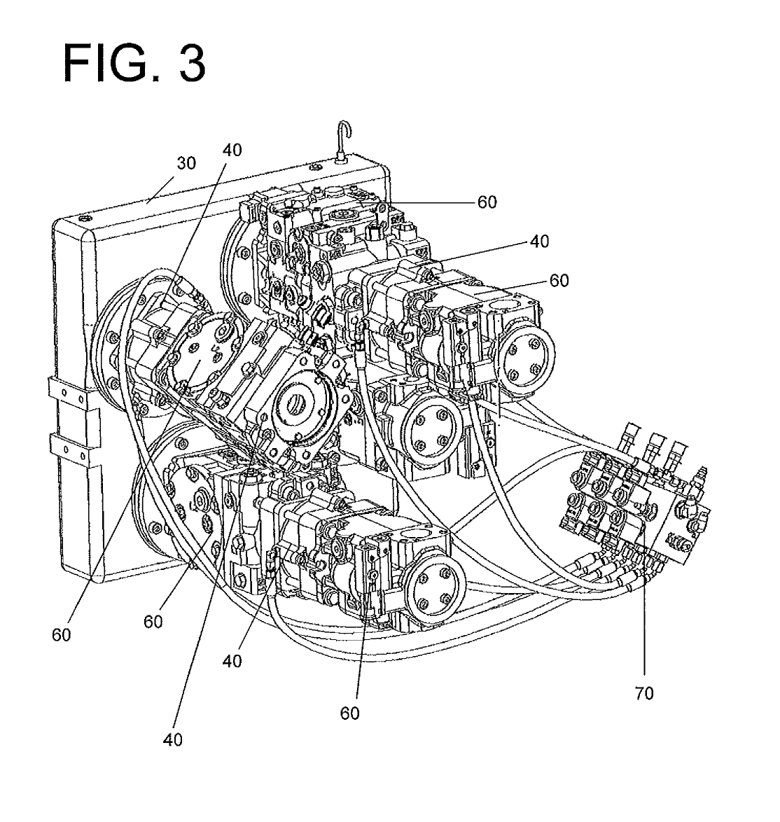

FIGS. 1 and 3 show a hydraulic power system 10 according to one embodiment of the present invention. As shown therein, the hydraulic power system includes an engine 20, a pump box 30, a plurality of hydraulic clutch packs 40, a plurality of hydraulic pumps 60, and a plurality of valves 70, a plurality of sensors 80-82, a hydraulic fluid reservoir 85, a clutch actuation pump 86, and one or more electronics 90, and a plurality of hydraulic actuators 100.

Turning now to FIG. 1, an engine 20 according to one embodiment is shown. According to one aspect of the present embodiment, the engine 20 is configured to supply mechanical power to the pump box 30. As shown in FIG. 1, the engine 20 includes an output 21, which transmits torque to the pump box 30. Those of ordinary skill in the art will appreciate that it is within the scope of the present invention to provide the output 21 with any shape and configuration that is capable of transmitting torque to the pump box 30.

The pump box 30 of the present embodiment is shown in FIGS. 1-3. As shown in FIG. 1, the pump box 30 may be interposed between the engine 20 and a plurality of hydraulic pumps 60. According to one aspect of the present embodiment, the pump box 30 is interposed between the engine 20 and a plurality of hydraulic pumps 60, whereby the pump box 30 receives mechanical power generated by the engine 20. According to another aspect of the present embodiment, the pump box 30 may be interposed between the engine 20 and a plurality of hydraulic pumps 60, whereby the pump box 30 transmits torque for use by the plurality of hydraulic pumps 60.

Also shown in FIG. 1, the pump box 30 may be interposed between the engine 20 and a clutch actuation pump 86. According to one aspect of the present embodiment, the pump box 30 may be interposed between the engine 20 and the clutch actuation pump 86, whereby the pump box 30 receives mechanical power generated by the engine 20. According to another aspect of the present embodiment, the pump box 30 may be interposed between the engine 20 and the clutch actuation pump 86, whereby the pump box 30 transmits torque for use by the clutch actuation pump 86.

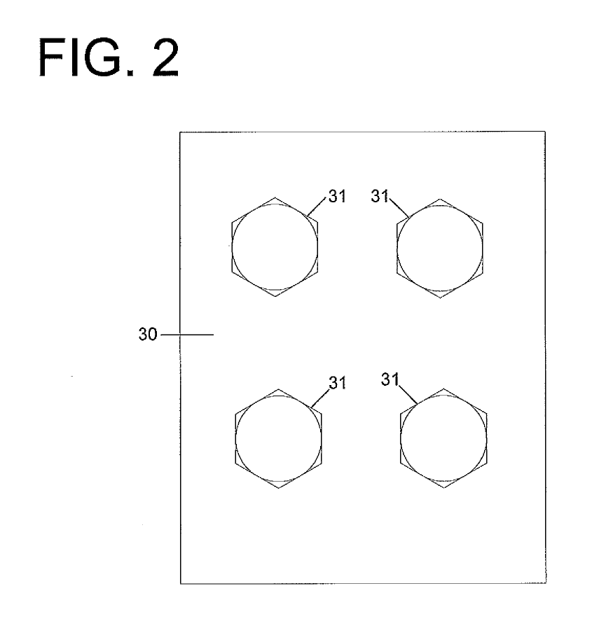

As shown in FIG. 1, the pump box 30 may receive torque from the engine 20, for example via an output shaft 21. Turning now to FIG. 2, the pump box 30 is provided with a plurality of outputs 31. Those of ordinary skill in the art appreciate that the outputs 31 receive torque supplied from the output shaft 21, such as, for example, via on or more torque transmitting structures (not shown), including for example gears. Although the presently depicted pump box 30 shows four outputs 31 for transmitting torque for use by the plurality of hydraulic pumps 60 and the clutch actuation pump 86, those of ordinary skill in the art will appreciate that it is within the scope of the present invention to provide a pump box 30 including any number of outputs 31, for example, more than or less than four. Those of ordinary skill in the art will also appreciate that it is within the scope of the present invention to provide the outputs 31 with any shape and configuration that is capable of transmitting torque.

Turning now to FIGS. 1 and 3, the hydraulic clutch packs 40 of the present embodiment are shown. According to one aspect of the present embodiment, the clutch packs 40 are configured to selectively transmit torque. According to another aspect of the present embodiment, the clutch packs 40 are configured to selectively transmit torque in response to a supply of hydraulic pressure.

As shown in FIGS. 1 and 3, the hydraulic clutch packs 40 may be interposed between the pump box 30 and the hydraulic pumps 60. According to one aspect of the present embodiment, the hydraulic clutch packs 40 may be interposed between the pump box 30 and the hydraulic pumps 60, whereby the clutch packs 40 receive torque from the pump box 30. According to another aspect of the present embodiment, the hydraulic clutch packs 40 may be interposed between the pump box 30 and the hydraulic pumps 60, whereby the clutch packs 40 selectively transmit torque for use by one or more downstream hydraulic pumps 60.

Also shown in FIGS. 1 and 3, the hydraulic clutch packs 40 may be interposed between hydraulic pumps 60. According to one aspect of the present embodiment, the hydraulic clutch packs 40 may be interposed between the hydraulic pumps 60, whereby the clutch packs 40 receive torque from one upstream hydraulic pump 60 and selectively transmit torque for use by one or more downstream hydraulic pumps 60.

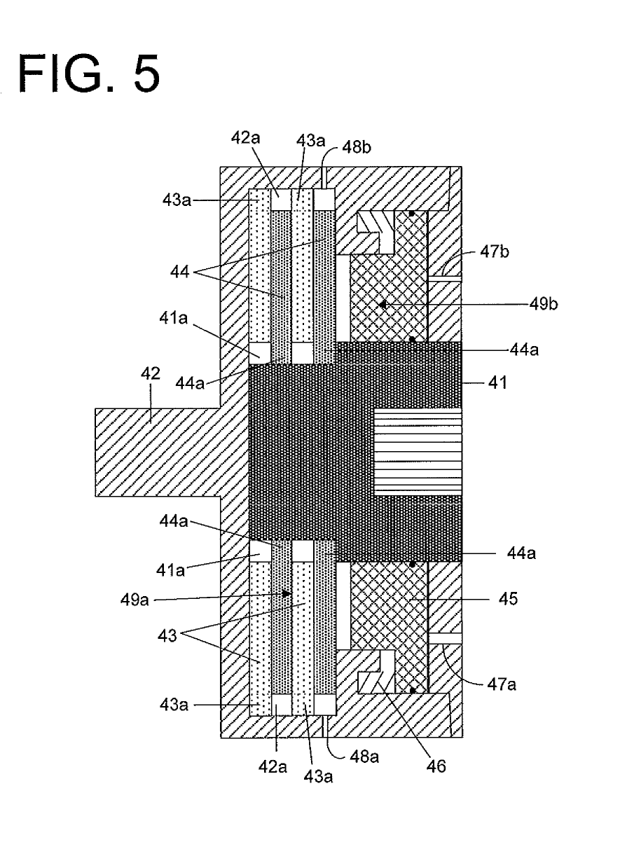

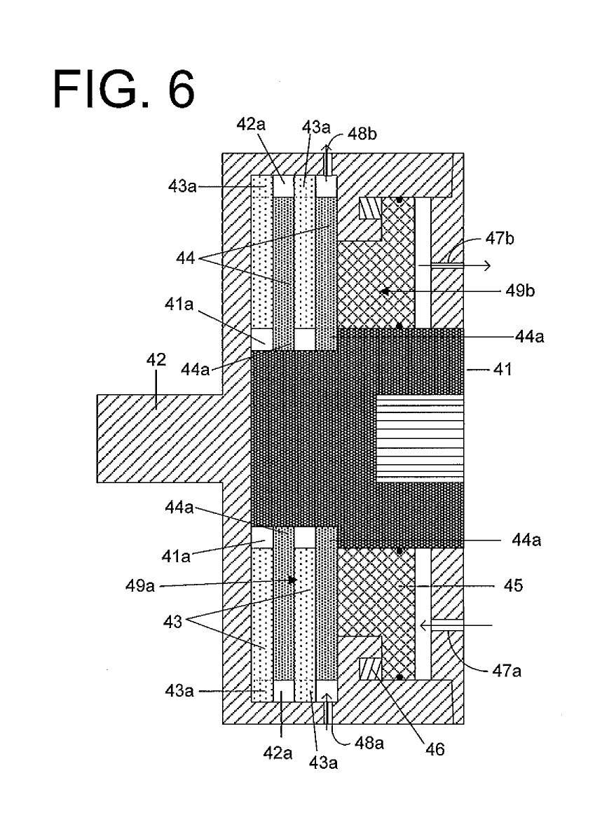

Turning now to FIGS. 5 and 6, an example of the working components of one type of clutch pack 40 is shown. As shown, therein, the clutch pack 40 is provided with a hub 41, externally splined as at 41a, a drum 42 internally splined as at 42a, a plurality of disks 43, externally splined as at 43a, a plurality of disks 44, internally splined as at 44a, a piston 45, and a biasing member 46.

As shown, the externally splined disks 43 are torsionally engaged and rotationally coupled to the internally splined drum 42, whereby rotation of one of the disks 43 or the drum 42 imparts rotation to the other of the disks 43 or the drum 42. Also shown, the internally splined disks 44 are torsionally engaged and rotationally coupled to the externally splined hub whereby rotation of one of the disks 44 or the hub 41 imparts rotation to the other of the disks 44 or the hub 41. Those of ordinary skill in the art will appreciate that while two externally splined disks 43 and two internally splined disks 44 are shown, it is within the scope of the present invention to utilize more than two of each type of disk 43, 44.

Those of ordinary skill in the art will appreciate that in operation either the externally splined hub 41 or the internally splined drum 42 receives torque from a source external to the clutch pack 40, for example, as shown in FIG. 1, from the pump box 30 or an upstream hydraulic pump 60 as shown in FIG. 1. Those of ordinary skill in the art will appreciate that either the externally splined hub 41 or the internally splined drum 42 selectively transmit torque to one or more downstream hydraulic pumps 60 or one or more downstream hydraulic clutches 40.

As shown in FIGS. 5 and 6, the clutch packs 40 selectively transmit torque according to the position of the piston 45, which is actuated via hydraulic pressure and the biasing member 46. As shown in FIG. 5, absent the application of hydraulic pressure, the clutch pack 40 is disengaged and the piston 45 is biased away from the disks 43, 44, via the biasing member 46, such as, for example, a spring. When the clutch is disengaged, the disks 43 and the disks 44 are rotationally uncoupled, whereby relative rotation occurs between the disks 43 and 44 as the pump box 30 or an upstream hydraulic pump 60 applies torque to one of the hub 41 or the drum 42. The rotational uncoupling of the disks 43 and 44 permit one of the hub 41 or the drum 42 to rotate independently from the other of the hub 41 or the drum 42. Accordingly, when the hydraulic clutch pack 40 is disengaged torque is not transmitted by the hydraulic clutch pack 40 to one or more downstream hydraulic pumps 60 or one or one or more downstream hydraulic clutches 40.

As shown in FIG. 6, application of hydraulic fluid pressure, for example introduced via port 47a, engages the clutch pack 40. When the clutch pack 40 is engaged the hydraulic fluid pressure exceeds the biasing force exerted by the biasing member 46 and biases the piston 45 towards the disks 43, 44. As this occurs, the piston 45 applies force to the disks 43, 44. The applied force squeezes the disks 43, 44 together and due to frictional forces, the disks 43, 44 are rotationally coupled, whereby rotation of one of the disks 43 or 44 imparts rotation to the other of the disks 43 or 44. The rotational coupling of the disks 43, 44 permits rotation of one of the hub 41 or the drum 42 to be translated as rotation to the other of the hub 41 or the drum 42.

Accordingly, when the clutch pack 40 is engaged torque may be selectively transmitted to one or more downstream hydraulic pumps 60, which, in turn, may supply hydraulic fluid pressure, for example by pumping hydraulic fluid from the hydraulic fluid reservoir 85, in order to operate one or more hydraulic actuators 100. Although FIG. 1 shows only two hydraulic actuators 100, those of ordinary skill in the art will appreciate that it is within the scope of the present invention for each hydraulic pump 60 to control an individual hydraulic actuator 100 or for any two hydraulic pumps 60 to control an individual hydraulic actuator 100.

Further, when the clutch pack 40 is engaged torque may be selectively transmitted to one or more downstream clutch packs 40, which, in turn, may selectively transmit torque to one or more hydraulic pumps 60.

Once engaged, when it is desired to disengage the hydraulic clutch pack 40, the supply of hydraulic fluid pressure is interrupted. Once the supply is interrupted, the hydraulic fluid pressure is reduced as the hydraulic fluid exits the piston chamber 49b for example via port 47b and the biasing member 46 biases the piston 45 away from the disks 43, 44, whereby the disks 43, 44 are rotationally uncoupled and the hydraulic clutch pack 40 disengaged. Although this arrangement may be particularly desirable since it ensures the clutch packs 40 are normally disengaged, including during engine starting, which may be particularly desirable during cold weather engine starting, those of ordinary skill in the art will appreciate that in alternative embodiments, hydraulic pressure may be used to disengage the clutch packs 40 and the biasing member 46 may be used to engage the clutch packs 40, whereby the clutch packs 40 are normally engaged.

Turning now to FIG. 1 the hydraulic fluid reservoir 85, the clutch actuation pump 86, the plurality of valves 70, and one or more electronics 90 are shown. According to one aspect of the present embodiment, the clutch actuation pump 86 pumps hydraulic fluid from the fluid reservoir 85. According to another aspect of the present embodiment, the clutch actuation pump 86 pumps the hydraulic fluid to the plurality of valves 70, which, in turn, selectively supply hydraulic fluid pressure to the plurality of clutch packs 40 in order to selectively engage the clutch packs 40. According to yet another aspect of the present embodiment, the clutch actuation pump 86 pumps the hydraulic fluid to the plurality of valves 70, which, in turn, selectively supply hydraulic fluid pressure to the plurality of clutch packs 40 in order to selectively regulate the temperature of clutch packs 40, including for example, to prevent overheating of the clutch packs 40. Those of ordinary skill in the art will appreciate that the valves 70 may be any type of valve, including, but not limited to a solenoid valve, that is capable of selectively opening and closing to selectively supply hydraulic fluid pressure to the clutch packs 40.

According to another aspect of the present embodiment, the one or more electronics 90 control the opening and closing of individual valves 70 in order to regulate the supply of pressurized hydraulic fluid to the clutch packs 40. According to yet another aspect of the present embodiment, the one or more electronics 90 control the opening and closing of individual valves 70 in order to regulate the supply of pressurized hydraulic fluid to the clutch packs 40 for purposes of selectively engaging the clutch packs 40. According to still yet another aspect of the present embodiment, the one or more electronics 90 control the opening and closing of individual valves 70 in order to regulate the supply of pressurized hydraulic fluid to the clutch packs 40 for purposes of selectively regulating the temperature of the clutch packs 40.

Turning now to FIGS. 5 and 6, the clutch packs 40 include port 47a, wherein hydraulic fluid may be selectively introduced to the clutch pack 40 in order to selectively engage the clutch pack 40. Also shown in FIGS. 5 and 6, the clutch packs 40 may be provided with a port 48a in fluid communication with the disks 43, 44, whereby hydraulic fluid may be introduced into the disk receiving portion 49a of the clutch pack 40 in order to selectively regulate the temperature of the clutch packs 40, including for example, for purposes of cooling the clutch packs 40 while the clutch packs 40 are engaged. As shown the hydraulic fluid may exit the disk receiving portion 49a via a second port 48b. Those of ordinary skill in the art will appreciate that the selective introduction of hydraulic fluid for purposes of cooling and engaging the clutch packs 40 may be controlled by the opening and closing of valves 70, which may be controlled by the one or more electronics 90.

Advantageously, the one or more electronics 90, which may be provided as one or more microprocessors, may take a variety of factors into account when controlling the opening and closing of the one or more of the valves 70 for purposes of selectively supplying hydraulic fluid to the clutch packs 40. Those of ordinary skill in the art will appreciate that the one or more electronics 90 may include software for this purpose.

By way of example, and not limitation, the one or more electronics 90 may control the supply of hydraulic fluid to the clutch packs 40 according to the temperature of the engine or the environmental temperature, including for example for purposes of disengaging the hydraulic load associated with operation of the plurality of hydraulic pumps 60 during cold engine starting conditions, such as those encountered during cold weather, i.e. for example temperatures at or below 32° F. As shown in FIG. 1 one or more sensors 80 may provide the one or more electronics 90 with information related to the temperature of the engine 20. Those of ordinary skill in the art will appreciate that it is within the scope of the present invention to provide one more additional sensors which convey environmental temperature information.

By way of yet another example, and not limitation, the one or more electronics 90 may control the supply of hydraulic fluid used to selectively regulate the temperature of the clutch packs 40 according to the temperature of the hydraulic fluid and according to whether the clutch packs 40 are engaged, including an amount of time the clutch packs 40 are continuously engaged or the amount of time engaged during a set period of time.

By way of yet another example, and not limitation, the one or more electronics 90 may control the supply of hydraulic fluid to the clutch packs 40 in order to increase fuel economy, reduce component wear on plurality of hydraulic pumps 60, reduce engine load, and reduce the buildup of heat in the hydraulic fluid. By way of example, in situations when one or more of the hydraulic actuators 100 are not being operated, the hydraulic clutch packs 40 may be disengaged in order to increase fuel economy, reduce component wear on plurality of hydraulic pumps 60, reduce engine load, and reduce the buildup of heat in the hydraulic fluid. As shown in FIG. 1, one or more sensors 81 maybe used to monitor whether a user is actually attempting to operate the hydraulic actuators 100. Also shown in FIG. 1, one or more sensors 82 may be used to monitor the temperature of the hydraulic fluid.

In addition to decreasing noise, those of ordinary skill in the art will appreciate that disengaging one or more clutch packs 40 removes the hydraulic load associated therewith, including the hydraulic load of any hydraulic pumps 60 driven by the clutch packs 40, from the engine 20 which in turn improves fuel economy. Additionally, as shown in FIG. 1, the one or more sensors 80 may be used to monitor fuel economy and engine load. In particular, the one or more electronics 90 may automatically control the operation and speed of the engine according to the hydraulic load exerted at any point in time, whereby automated adjustments in engine speed may occur in order to optimize fuel economy.

The detailed descriptions of the above embodiments are not exhaustive descriptions of all embodiments contemplated by the inventors to be within the scope of the invention. Persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention. Thus, although specific embodiments of, and examples for, the invention are described herein for illustrative purposes, various equivalent modifications are possible within the scope of the invention, as those skilled in the relevant art will recognize. Accordingly, the scope of the invention is determined from the appended claims.

I claim:

1. A hydraulic system, comprising:
an engine;
at least one hydraulic pump;
a pump box interposed between the engine and the at least one hydraulic pump, whereby the pump box receives mechanical power generated by the engine and transmits torque for use by the at least one hydraulic pump;
at least one hydraulic clutch pack interposed between the pump box and the at least one hydraulic pump for selectively transmitting torque to the at least one hydraulic pump, wherein the at least one clutch pack may be selectively engaged or disengaged, whereby the hydraulic load associated with the at least one hydraulic pump is applied to the engine when the clutch pack is engaged;
at least one valve that may be opened to supply pressurized hydraulic fluid to the at least one clutch pack and that may be closed to interrupt a supply of pressurized hydraulic fluid to the at least one clutch pack in order to selectively engage or disengage the clutch pack;
a hydraulic fluid reservoir;
a clutch actuation pump that pumps the hydraulic fluid from the hydraulic fluid reservoir to the at least one valve; and
one or more electronics which control the opening and closing of the at least one valve.

2. The hydraulic system according to claim 1, wherein the one or more electronics automatically adjusts the engine speed according to a hydraulic load applied to the engine in order to optimize fuel economy.

3. The hydraulic system according to claim 1, wherein the at least one valve supplies pressurized hydraulic fluid to selectively engage the at least one hydraulic clutch pack, whereby the at least one clutch pack is normally disengaged absent the supply of pressurized hydraulic fluid.

4. The hydraulic system according to claim 1, further comprising at least one other valve that supplies hydraulic fluid to the at least one hydraulic clutch pack in order to regulate the temperature of the hydraulic clutch pack.

5. The hydraulic system according to claim 1, further comprising at least one hydraulic actuator, wherein the at least one hydraulic pump pumps hydraulic fluid in order to operate the at least one hydraulic actuator.

6. The hydraulic system according to claim 1, further comprising at least one hydraulic actuator, wherein the at least one hydraulic pump pumps hydraulic fluid in order to operate the at least one hydraulic actuator and wherein the one or more electronics control the opening and closing of the valve in order to remove the hydraulic load associated with the at least one hydraulic pump from the engine when a user is not attempting to operate the at least one hydraulic actuator.

7. The hydraulic system according to claim 1, wherein the one or more electronics control the opening and closing of the valve in order to remove the hydraulic load associated with the at least one hydraulic pump from the engine during engine start up.

8. The hydraulic system according to claim 1, wherein the one or more electronics control the opening and closing of the valve in order to remove the hydraulic load associated with the at least one hydraulic pump from the engine during cold engine start up conditions.

9. A method for operating a hydraulic system that includes an engine, at least one hydraulic pump, a pump box interposed between the engine and the at least one hydraulic pump, whereby the pump box receives mechanical power generated by the engine and transmits torque for use by the at least one hydraulic pump, at least one hydraulic clutch pack interposed between the pump box and the at least one hydraulic pump for selectively transmitting torque to the at least one hydraulic pump, wherein the at least one clutch pack may be selectively engaged or disengaged, whereby the hydraulic load associated with the at least one hydraulic pump is applied to the engine when the clutch pack is engaged, a hydraulic fluid reservoir, and a clutch actuation pump that pumps the hydraulic fluid from the hydraulic fluid reservoir to at least one valve, the method comprising the step of:
selectively engaging or disengaging the clutch pack using one or more electronics to control the opening and closing of the at least one valve, wherein when the at least one valve is opened pressurized hydraulic fluid is supplied to the at least one clutch pack and wherein when the at least valve is closed the supply of pressurized hydraulic fluid to the at least one clutch pack is interrupted.

10. The method according to claim 9, further comprising the step of optimizing fuel economy by using the one or more electronics to automatically adjust the engine speed according to a hydraulic load applied to the engine.

11. The method according to claim 9, wherein the at least one valve supplies pressurized hydraulic fluid to selectively engage the at least one hydraulic clutch pack, whereby the at least one clutch pack is normally disengaged absent the supply of pressurized hydraulic fluid.

12. The method according to claim 9, wherein the hydraulic system further comprises at least one other valve and the method further comprises using the at least one other valve to supply hydraulic fluid the at least one hydraulic clutch pack in order to regulate the temperature of the hydraulic clutch pack.

13. The method according to claim 9, further comprising at least one hydraulic actuator, wherein the at least one hydraulic pump pumps hydraulic fluid in order to operate the at least one hydraulic actuator.

14. The hydraulic system according to claim 9, further comprising at least one hydraulic actuator, wherein the at least one hydraulic pump pumps hydraulic fluid in order to operate the at least one hydraulic actuator and wherein the step of selectively engaging or disengaging the clutch pack using one or more electronics includes using the one or more electronics to control the opening and closing of the valve in order to remove the hydraulic load associated with the at least one hydraulic pump from the engine when a user is not attempting to operate the at least one hydraulic actuator.

15. The hydraulic system according to claim 9, wherein the step of selectively engaging or disengaging the clutch pack using one or more electronics includes using the one or more electronics to control the opening and closing of the valve in order to remove the hydraulic load associated with the at least one hydraulic pump from the engine during engine start up.

16. The hydraulic system according to claim 9, wherein the step of selectively engaging or disengaging the clutch pack using one or more electronics includes using the one or more electronics to control the opening and closing of the valve in order to remove the hydraulic load associated with the at least one hydraulic pump from the engine during cold engine start up conditions.
